(19) United States
(12) Patent Application Publication
(10) Pub. No.: US 2006/0294101 A1
(43) Pub. Date: Dec. 28, 2006

(54) Multi-strategy document classification system and method

(75) Inventor: Janusz Wnek, Germantown, MD (US)

Correspondence Address: STERNE, KESSLER, GOLDSTEIN & FOX PLLC, 1100 NEW YORK AVENUE, N.W., WASHINGTON, DC, 20005, US

(73) Assignee: Content Analyst Company, LLC, Reston, VA (US)

(21) Appl. No.: 11/473,131

(22) Filed: Jun. 23, 2006

Related U.S. Application Data
(60) Provisional application No. 60/693,500, filed on Jun. 24, 2005.

(51) Int. Cl. G06F 7/00

(52) U.S. Cl. 707/7

(57) ABSTRACT

A system and method for the automated classification of documents. To generate a function for the automatic classification of documents, a set of similarity scores is calculated for each document in a set of exemplary documents, wherein a similarity score is calculated by measuring the similarity in a conceptual representation space between a document vector representing the document and a centroid vector representing a category. The set of similarity scores are then used by an inductive learning from examples classifier to generate the function for the automatic classification of documents.

### CROSS-REFERENCE TO RELATED APPLICATIONS

This application claims benefit under 35 U.S.C. § 119(e) to U.S. Provisional Patent Application 60/693,500, entitled “Multi-Strategy Document Classification System and Method,” to Wnek, filed on Jun. 24, 2005, the entirety of which is hereby incorporated by reference as if fully set forth herein.

### BACKGROUND OF THE INVENTION

1. Field of the Invention

The present invention is generally directed to the field of automated document processing, and in particular to the field of automated document classification.

2. Background

The latent semantic indexing (LSI) technique has been used to create a specific class of supervised classifiers that are based on samples of pre-categorized exemplary documents. This technique has been referred to as the “LSI information filtering technique”. The basic concepts underlying LSI are described in U.S. Pat. No. 4,839,853 to Deerwester et al., entitled “Computer Information Retrieval Using Latent Semantic Structure”, the entirety of which is incorporated by reference herein. Details concerning the LSI information filtering technique may be found in the following references, each of which is incorporated by reference herein: Foltz, P. W., “Using Latent Semantic Indexing for Information Filtering”, from R. B. Allen (Ed.), Proceedings of the Conference on Office Information Systems, Cambridge, Mass. (1990), pp. 40-47; Foltz, P. W. and Dumais, S. T., “Personalized information delivery: An analysis of information filtering methods.” Communications of the ACM, 35(12), (1992), pp. 51-60; Dumais, S. T., “Using LSI for information filtering: TREC-3 experiments” in D. Harman (Ed.), The Third Text Retrieval Conference (TREC3) National Institute of Standards and Technology Special Publication (1995); and Dumais, S. T., “Combining evidence for effective information filtering” in AAAI Spring Symposium on Machine Learning and Information Retrieval, Tech Report SS-96-07, AAAI Press (1996).

The LSI information filtering technique is premised on the feature of LSI that documents describing similar topics tend to cluster in the LSI space. In its simplest form, the technique involves creating an LSI space from a set of pre-categorized documents and then categorizing new documents based on closeness to a given category of documents in the LSI space. The closeness to a category is determined based on an analysis of a predetermined number of the top matching documents of a known category.

However, the LSI self-clustering feature is imperfect. In his early research, P. W. Foltz noticed that “any cluster of articles may contain both relevant and non-relevant articles. Therefore, it is necessary to develop measures to determine whether a new article is relevant based on some characteristics of what is returned.” See Foltz, P. W., “Using Latent Semantic Indexing for Information Filtering”, from R. B. Allen (Ed.), Proceedings of the Conference on Office Information Systems, Cambridge, Mass., pp. 40-47. Foltz used two criteria for determining if a document is relevant to a category. The first criterion assumed that a document was relevant to a given category if it was close to any exemplary document in that category. The second criterion assumed that “a high ratio of relevant to non-relevant articles close to the new article would indicate that the new article is probably relevant.” Although the two criteria may be adequate for some document categorization cases, in general they will not cover the variety of concepts expressed in exemplary document collections and concepts attached to the data.

Thus, while LSI information filtering can be viewed as a document classification technique, its underlying assumptions pertaining to relevancy make it limited for a broad application to variety of classification tasks. Moreover, because the training examples used in the technique have no explicit structure, they cannot be combined into a single centroid vector, or set of centroid vectors, based on similarities among the training examples within a certain category. Furthermore, because the technique only matches documents to the most similar exemplary documents, it does not analyze dissimilarity information. Such analysis can be useful in achieving a more sophisticated classification function.

Some of the shortcomings of the LSI information filtering technique have been addressed by organizing the exemplary material into concept trees. See Price, R. J. and Zukas, A., “Document Categorization Using Latent Semantic Indexing,” 2003 Symposium on Document Image Understanding Technology, Greenbelt, Md. (2003), the entirety of which is incorporated by reference herein. However, such an approach has a major limitation in that it assumes a predefined function for selecting the classification category. For example, the most commonly-used function selects the category of the best matching exemplar or a centroid representing a group of exemplars that belong to the same category.

### BRIEF SUMMARY OF THE INVENTION

The present invention provides an improved automated system and method for classifying documents and other data. In part, the present invention provides a more flexible solution for approximating the function that determines classification category as compared to prior art LSI information filtering. In accordance with one aspect of the invention, the function is derived in an inductive way from pre-classified “scoring vectors” that represent original documents after scoring them using LSI-based classifiers.

The present invention has several advantages and provides some new unique capabilities not previously available. For example, in accordance with one aspect of the present invention, the exemplars defining a concept category may be clustered in order to enhance LSI scoring capability. Moreover, instead of using a predefined classification function that combines the output of several LSI-based classifiers, a method in accordance with the present invention approximates the classification function by applying inductive learning from examples. This alone has a potential of improving document classification. In addition, the integration of LSI modeling with this new paradigm allows for an easy incorporation of additional, non-textual information into the classifier (e.g., relational data or descriptors characterizing signals such as image or audio), as well as performing constructive induction, i.e., changing the representation space, which may involve selecting and generating new descriptors.

The seamless integration of the information retrieval technique with the inductive learning from examples paradigm opens new application opportunities where data is represented in both an unstructured form (e.g., text, images, or signals) and a structured form (e.g., databases).

In addition to the foregoing, the present invention provides a method for enhancing the LSI structuring of learned concepts in the LSI representation space. In accordance with this method, before indexing exemplary documents for classification purposes, textual category labels associated with the exemplary documents are concatenated with the document text. Furthermore, exemplary documents in the same category are combined to form new exemplary documents from which the LSI representation space is created. As will be described in more detail herein, this combining may be achieved by combining adjacent pairs of documents in a series of exemplary documents in a “chain link” fashion.

Further features and advantages of the invention, as well as the structure and operation of various embodiments of the invention, are described in detail below with reference to the accompanying drawings. It is noted that the invention is not limited to the specific embodiments described herein. Such embodiments are presented herein for illustrative purposes only. Additional embodiments will be apparent to persons skilled in the relevant art(s) based on the teachings contained herein.

### BRIEF DESCRIPTION OF THE DRAWINGS/FIGURES

The accompanying drawings, which are incorporated herein and form part of the specification, illustrate the present invention and, together with the description, further serve to explain the principles of the invention and to enable a person skilled in the relevant art(s) to make and use the invention.

FIG. 1 is a flowchart of an automated method for classifying documents in accordance with the present invention.

FIGS. 2 and 4 illustrate LSI-based classification of categorized subsets of documents in accordance with alternate implementations of the present invention.

FIGS. 3 and 5 illustrate the generation of “scoring vectors” corresponding to exemplary documents in accordance with alternate implementations of the present invention.

FIG. 6 depicts an example computer system in which the present invention may be implemented.

FIG. 7 depicts an example set of records including structured and unstructured data that may be classified in an automated fashion in accordance with the present invention.

FIGS. 8 and 9 illustrate LSI-based classification and scoring of fields of unstructured text in accordance with an example implementation of the present invention.

FIG. 10 illustrates the generation of records for input to an inductive learning from examples program in accordance with an implementation of the present invention.

FIGS. 11 is a table that illustrates the matching of document vectors to concepts compatible with LSI clustering in a representative space created in accordance with standard LSI and in a representative space created in accordance with an embodiment of the present invention.

FIG. 12 is a table that illustrates the matching of document vectors to concepts incompatible with LSI clustering in a representative space created in accordance with standard LSI and in a representative space created in accordance with an embodiment of the present invention.

FIG. 13 is a flowchart of a method for providing an augmented set of exemplary documents for use in generating a representation space with enhanced conceptual structuring in accordance with an embodiment of the present invention.

FIG. 14 is a table illustrating the matching of document vectors to concepts incompatible with LSI clustering in a representative space created in accordance with LSI and in a representative space created in accordance with an embodiment of the present invention.

The features and advantages of the present invention will become more apparent from the detailed description set forth below when taken in conjunction with the drawings, in which like reference characters identify corresponding elements throughout. In the drawings, like reference numbers generally indicate identical, functionally similar, and/or structurally similar elements. The drawing in which an element first appears is indicated by the leftmost digit(s) in the corresponding reference number.

### DETAILED DESCRIPTION OF THE INVENTION

A. Overview

A system and method in accordance with the present invention combines the output from one or more LSI classifiers according to an inductive bias implemented in a particular learning method. An inductive learner from examples is used to approximate the function. Currently, many inductive learners are available spanning decision tree and decision rule methods, probabilistic methods, neural networks, as implemented, for example, in the WEKA data mining tool kit. See Witten, I. H. and Frank, E., “Data Mining: Practical machine learning tools with Java implementations,” Morgan Kaufmann, San Francisco (2000), the entirety of which is incorporated by reference herein.

In accordance with one aspect of the present invention, before applying an inductive learning method from examples, the output from the LSI classifiers may be augmented with additional document characteristics which are not captured by the LSI representation. To this end, every vector describing a document is augmented with additional dimensions (attributes) reflecting new measurements. For example, additional attributes may include the length of the document, the date and place it was created, layout, formatting, publishing characteristics, a score from an alternative scoring program, or the like. See Wnek, J., “High-Performance Inductive Document Classifier,” SAIC Science and Technology Trends II, Clinton W. Kelly, III (ed.), May 1998, which is incorporated by reference in its entirety herein.

In addition, the invention may be explicitly applied to the databases that contain categorized data in both structured (e.g., relational). and unstructured (e.g., textual, image, or other signal) form.

B. Method for Performing Automated Document Classification

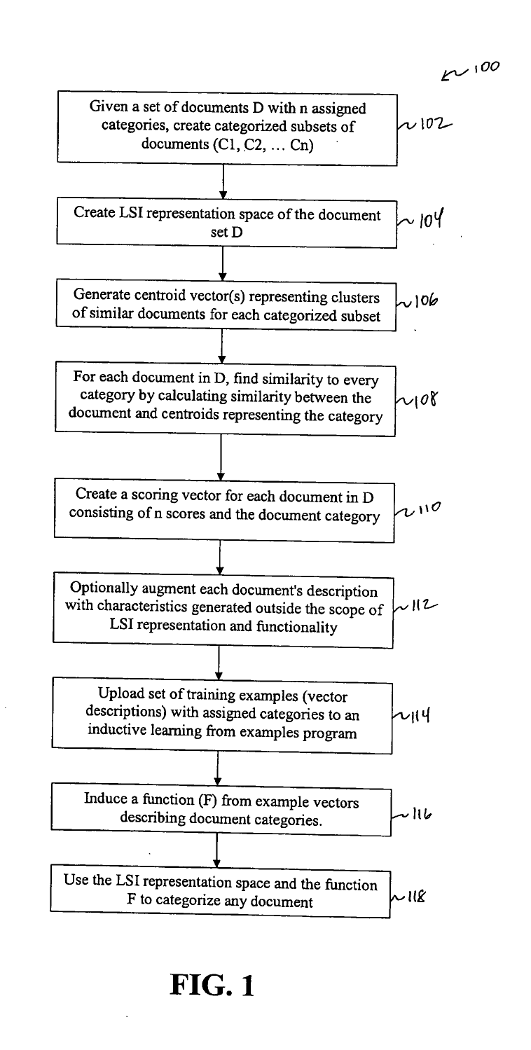

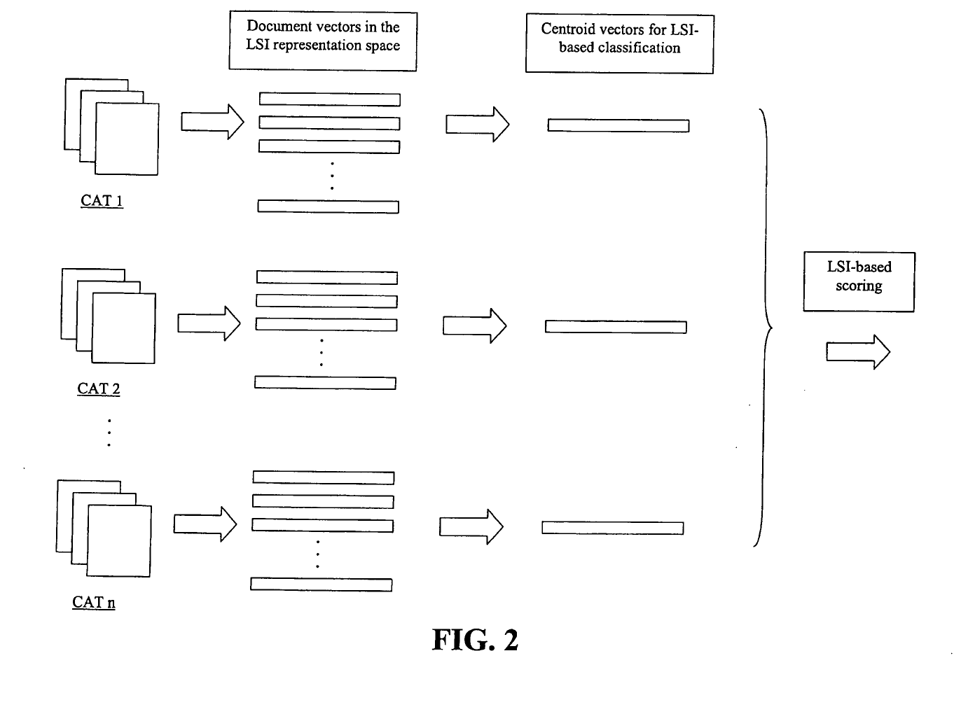

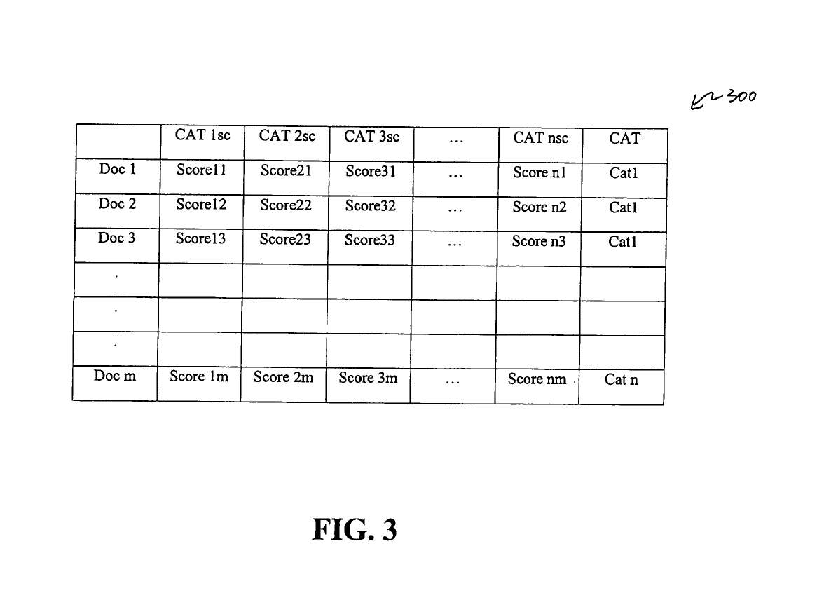

FIG. 1 depicts a flowchart 100 of a method for performing automated document classification in accordance with the present invention. The invention, however, is not limited to the description provided by the flowchart 100. Rather, it will be apparent to persons skilled in the relevant art(s) from the teachings provided herein that other finctional flows are within the scope and spirit of the present invention. For the purposes of clarity, certain steps of flowchart 100 will be described with reference to illustrations provided in FIGS. 2 and 3.

The method of flowchart 100 assumes the existence of a set of documents D and n predefined categories of interest. As used herein, the term “document” encompasses any discrete collection of text or other information, such as, for example, feature descriptors characterizing signals such as image or audio. Documents are preferably stored in electronic form to facilitate automated processing thereof, as by one or more computers. The method of flowchart 100 further assumes that the set of documents D includes a plurality of exemplary documents (or “exemplars”), each exemplary document being representative of and assigned to one or more of the n predefined categories.

The method of flowchart 100 begins at step 102, in which categorized subsets of documents (C1, C2, . . . Cn) are created by sorting the exemplary documents within the set of documents D according to their assigned categories. With reference to the illustration of FIG. 2, these categorized subsets of documents are shown as the distinct sets of documents labeled “CAT 1”, “CAT 2”, through “CAT n”.

At step 104, an LSI representation space is created for the set of documents D. An example of the creation of an LSI representation space is provided in U.S. Pat. No. 4,839,853 to Deerwester et al., entitled “Computer Information Retrieval Using Latent Semantic Structure”, the entirety of which is incorporated by reference herein. As a result of the creation of the LSI space, each document in each category is represented by a document vector in the LSI representation space. These document vectors are illustrated in FIG. 2 under the box labeled “Document vectors in the LSI representation space.”

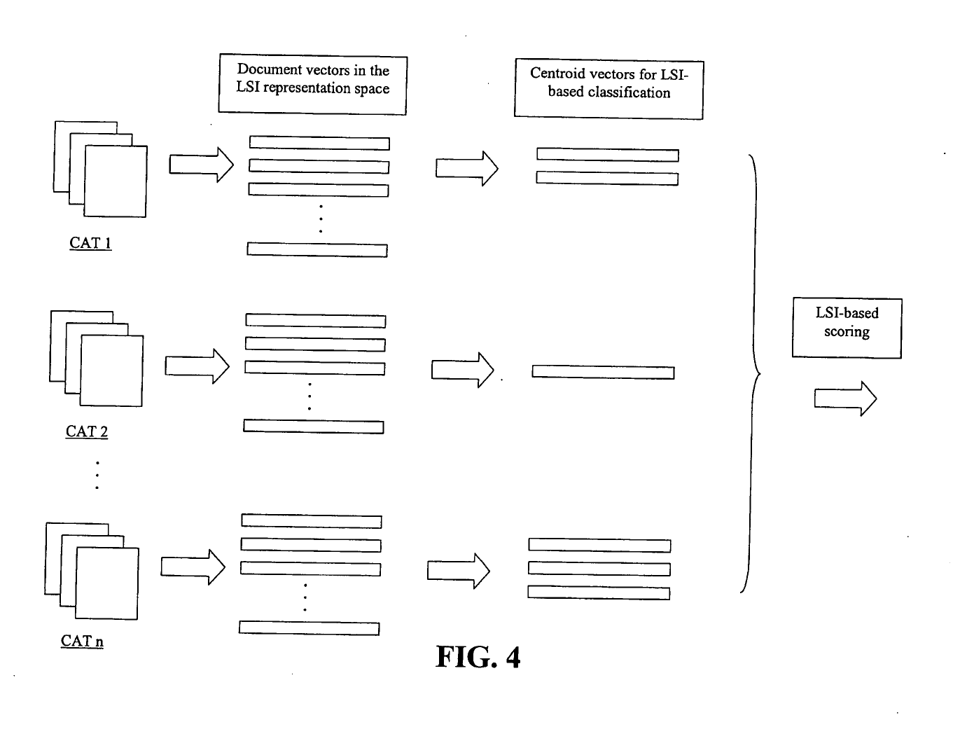

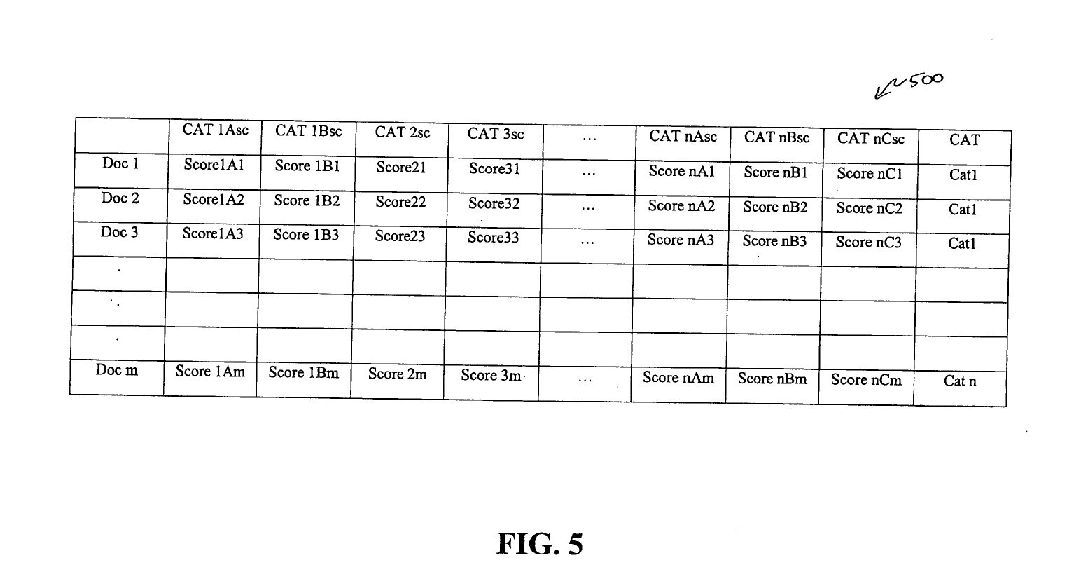

At step 106, one or more centroid vectors are generated that represent clusters of similar documents for each categorized subset. Centroid vectors comprise the average of two or more document vectors and may be generated by multiplying document vectors together. In the case where an exemplary document is not included in a cluster, a copy of its vector is used as a centroid for classification purposes. FIG. 2 illustrates the simplest case in which all document vectors for a categorized subset are combined into a single centroid vector. The centroid vectors are shown beneath the box labeled “Centroid vectors for LSI-based classification” in FIG. 2. As will be discussed below with reference to FIGS. 4 and 5, in an alternative implementation, the document vectors for a categorized subset may be combined into multiple centroid vectors.

At step 108, LSI-based scoring is utilized to determine the similarity between each document in set D and each category. This step is represented in FIG. 2 by the box labeled “LSI-based scoring”. In particular, for each document in set D, a similarity between the document and the centroid(s) representing each category is calculated. As will be appreciated by persons skilled in the relevant art(s), a cosine or dot product metric may be applied to determine the similarity between two vectors in the LSI representation space, although the invention is not so limited. The similarity measurement is quantified in terms of a score. For example, in one implementation, the similarity is expressed in terms of integer scores between 0 and 100, wherein a larger integer score indicates greater degree of similarity.

At step 110, a “scoring vector” is created for each document in set D based at least upon the n similarity scores generated for the document in step 108 and upon the document category to which the document has been assigned.

An example of the generation of “scoring vectors” is further illustrated by table 300 of FIG. 3. As shown in FIG. 3, each of documents 1 through m in set D is assigned its own row in table 300. This is indicated by row headings “Doc 1”, “Doc 2,” “Doc 3,” through “Doc m” appearing on the left-hand side of table 300. As also shown in FIG. 3, a column is provided for storing each of the n similarity scores generated for each document in step 108. Thus, for example, the similarity score for document 1 and the centroid vector of category 1 (denoted “Score11”) is stored in row “Doc 1”, column “CAT 1sc”. Likewise, the similarity score for document 1 and the centroid vector of category 2 (denoted “Score21”) is stored at row “Doc 1”, column “CAT 2sc”, and so forth and so on. In addition to the columns provided for storing the similarity scores for each document, a final column labeled “CAT” is provided for storing the category to which each document was originally assigned. In accordance with table 300, then, the scoring vector for each document 1 through m in set D is the data stored in the row associated with each document (i.e., the similarity scores for each document as calculated in step 108 and the category to which the document is assigned).

It is noted that the table of FIG. 3 is provided for ease of explanation and because it is one of the accepted standard data formats for inductive learners, as implemented in WEKA. However, the invention is not limited to the use of a table to generate scoring vectors. Rather, any suitable data structure(s) for storing scoring vectors may be utilized.

At step 112, each document's vector description can optionally be further augmented by adding additional characteristics or attributes generated outside the scope of LSI representation and functionality. For example, additional attributes may include the length of the document, the date and place it was created, layout, formatting, publishing characteristics, a score from an alternative scoring program, or the like.

At step 114, the set of training examples (vector descriptions) including assigned categories are uploaded to an inductive learning from examples program.

At step 116, the inductive learning from examples program induces a function (F) from the example vectors describing document categories. This function both combines evidence described using the attributes and differentiates description of a given category from other categories. The function may be implemented as a decision rule, decision tree, neural network, probabilistic network induction, or the like. For example, a decision rule that might be generated in accordance with the foregoing examples might take the following form:

IF (CAT1sc<20 AND CAT5sc>80) THEN CAT5

ELSE IF (CAT3sc>15 AND CAT1sc>60) THEN CAT3

ELSE . . .

At step 118, the LSI representation space and the function F is used to categorize any document. Categorization in accordance with step 118 is carried out by first representing the document in the LSI space. This can be achieved by including the document with the set of documents originally used to create the LSI space. Alternatively, the document can be folded into the LSI space subsequent to its creation. Once represented in the LSI space, the document is classified using the centroid vectors (e.g. based on its proximity to the centroid vectors). Then the similarity between the document and each of the centroid vectors is measured and a “scoring vector” is generated for the document. Finally, the document is evaluated using the function F.

FIG. 4 illustrates an alternate implementation in which multiple centroid vectors can be generated in step 106 to represent clusters of similar documents for each categorized subset. For example, as shown in FIG. 4, two centroid vectors are generated to represent category 1 (CAT 1) documents, a single centroid vector is generated to represent category 2 (CAT 2) documents, and three centroid vectors are generated to represent category 3 (CAT 3) documents. The determination as to how many centroid vectors should be generated may be based on how exemplary documents within a given category cluster within the LSI representation space. Thus, for example, if documents within a given category generate two distinct clusters, two centroid vectors can be used to represent the category.

FIG. 5 provides an example of a table 500 used to generate “scoring vectors” for the system illustrated in FIG. 4. As shown in FIG. 5, two columns are provided to store the similarity scores calculated by comparing each document to the two category one centroids-namely “Cat 1Asc” and “Cat 1Bsc”. Likewise, three columns are provided to store the similarity scores calculated by comparing the each document to the three category n centroids-namely “Cat nAsc”, “CatnBsc” and “CatnCsc”. Alternatively, one score per category could be produced by taking the maximum score among the centroids in that category. As noted above, the invention is not limited to the use of a table to generate scoring vectors and any suitable data structure(s) may be used.

C. Automatic Classification Based on Structured and Unstructured Data

The present invention facilitates the seamless integration of an information retrieval technique with the inductive learning from examples paradigm. As will be described in more detail below, this innovation opens new application opportunities where data is represented in both an unstructured form (e.g., text) and a structured form (e.g., databases).

For many conventional inductive learners from examples, input is provided in the form of relational database records consisting of crisply-defined fields having pre-determined or easily-determined attributes and formats. Because this data is structured, it is well-suited for comparative analysis by the inductive learner and can be used to generate and apply fairly straightforward classification rules. In contrast, unstructured data such as text is difficult to analyze and classify. Thus, many conventional inductive learners from examples do not operate on fields with unstructured text. Alternatively, some inductive learners from examples will process only a few selected keywords from a field of unstructured text rather than the text itself. However, this latter approach provides the inductive learner from examples with only a very limited sense of the content of the unstructured text.

The present invention provides a novel technique for performing automated classification of records using an inductive learner from examples and based on both fields of structured and unstructured text. An example implementation of the invention will now be described with reference to FIGS. 7-10.

In particular, FIG. 7 illustrates a database 700 that includes a plurality of records, each record having a plurality of fields of structured data (the fields labeled “field 1”, “field 2” and “field 3”), a plurality of fields of unstructured data (the fields labeled “Text 1” and “Text 2”), and a field indicating a category to which the record has been assigned (the field labeled “CAT”).

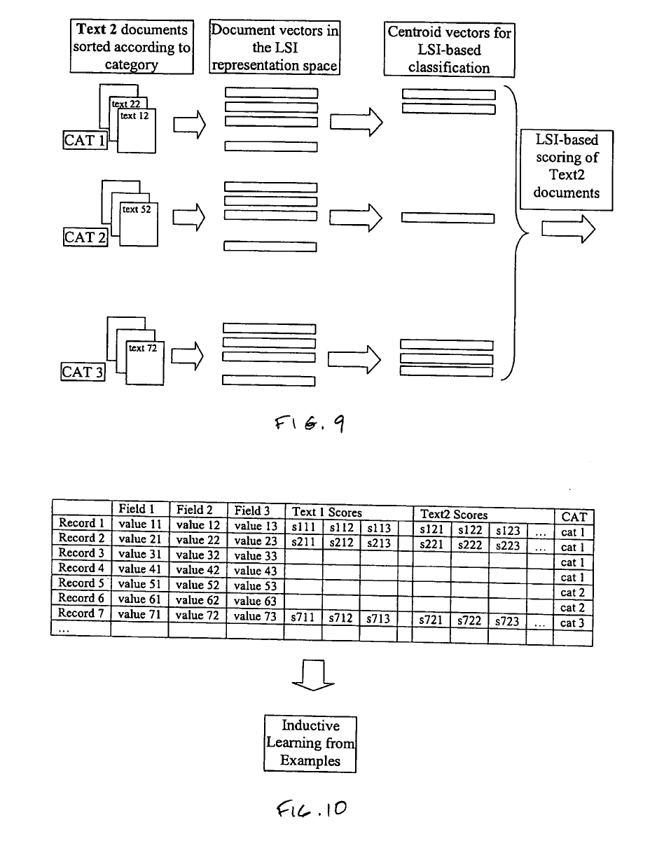

As shown in FIG. 8, the Text 1 documents are sorted according to their assigned category and then used to generate an LSI representation space. The document vectors corresponding to each category are then used to generate one or more centroid vectors for each category. LSI-based scoring is then utilized to determine the similarity between each Text 1 document and the centroid(s) representing each category. These LSI-based scores are then stored in a modified set of database records, as illustrated in FIG. 10 (under the heading “Text 1 Scores”).

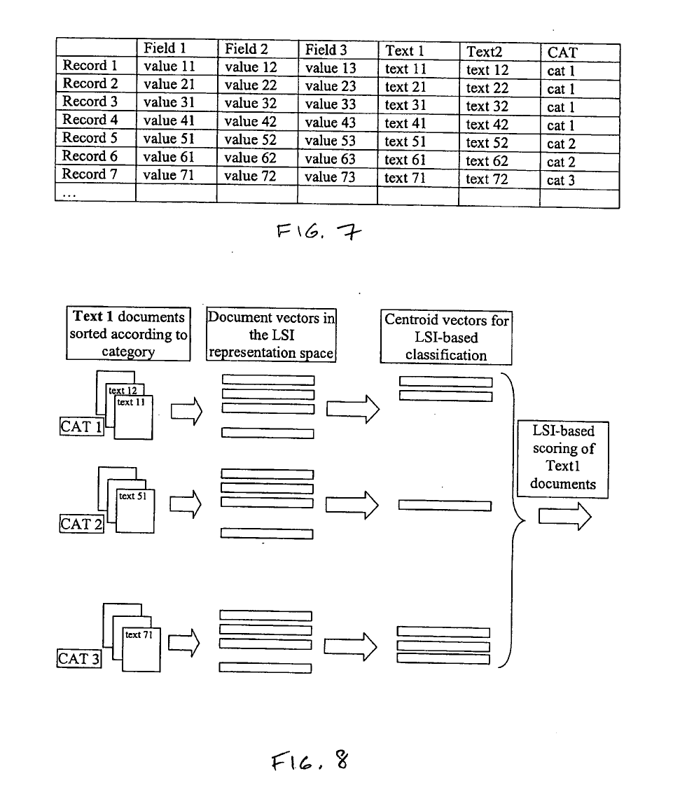

As shown in FIG. 9, a similar process is also carried out for the Text 2 documents. That is, the Text 2 documents are sorted according to their assigned category and then used to generate an LSI representation space. The document vectors corresponding to each category are then used to generate one or more centroid vectors for each category. LSI-based scoring is then utilized to determine the similarity between each Text 2 document and the centroid(s) representing each category. These LSI-based scores are then stored in the modified set of database records illustrated in FIG. 10 (under the heading “Text 2 Scores”).

The database records illustrated in FIG. 10 are then used as the input to an inductive learning from examples program, which uses the input to induce a function describing record categories. The function is thus based on the structured data fields (“field 1”, “field 2” and “field 3”), the assigned category (“CAT”), and the unstructured data fields in that the LSI-based scores (“Text 1 Scores and Text 2 Scores”) for each record are used as input by the program. The function may be implemented as a decision rule, decision tree, neural network, probabilistic network induction, or the like.

The function can then be used to categorize any record. Categorization is carried out by first generating LSI-based scores for the Text 1 and Text 2 fields of a given record. These scores are generated by representing a text field in the appropriate LSI representation space and then measuring the similarity between the text field and each of the centroid vectors. The record is then evaluated using the function F based on the structured data fields (“field 1”, “field 2” and “field 3”), and the LSI-based scores (“Text 1 Scores and Text 2 Scores”).

D. Expanding the LSI Semantic Representation with Concept Representation

As described above in reference to flowchart 100 of FIG. 1, an embodiment of the present invention creates an LSI representation space based on a set of exemplary documents D, each of which is assigned to one of n categories. The following describes a method that can be optionally used prior to building the LSI representation space in step 104 that enhances the LSI structuring of the learned concepts in the representation space. When used prior to step 104, the method essentially provides a pre-processing step that creates an altered or “enhanced” set of exemplary documents D for use in creating the LSI representation space in step 104.

Before describing this new method, the following description will first demonstrate the learning of concepts in LSI representation spaces. In order to more clearly demonstrate this subject, the set of nine short documents described by Deerwester et al. in U.S. Pat. No. 4,839,853 (the entirety of which is incorporated by reference herein) will be used. Each of the nine documents consists of the title of a technical document, with titles c1−c5 concerned with human/computer interaction and titles m1−m4 concerned with mathematical graph theory. The titles are reproduced herein:

c1: Human machine interface for Lab ABC computer applications

c2: A survey of user opinion of computer system response time

c3: The EPS user interface management system

c4: Systems and human systems engineering testing of EPS-2

c5: Relation of user-perceived response time to error measurement

m1: The generation of random, binary, unordered trees

m2: The intersection graph of paths in trees

m3: Graph minors IV: Widths of trees and well-quasi-ordering

m4: Graph minors: A survey.

In U.S. Pat. No. 4,839,853, the documents c1−c5 and m1−m4 were used to demonstrate the ability of LSI to cluster semantically similar documents. In fact, the c1−c5 and m1−m4 documents were shown to reside in separate areas of the LSI representation space. Such a feature ensures retrieval of semantically similar documents because they are grouped in close proximity to each other in the LSI space.

Information retrieval is different however from concept learning, where the concept may be defined by the contents of several exemplary documents but those documents may not always be in close proximity with one another in the LSI space. To illustrate this point, concept learning from documents that form clusters in the LSI space will first be demonstrated. Then, using the same set of documents, different concepts will be defined, and the results of classification will be shown. In this demonstration, learning a concept from exemplary documents is carried out by creating a centroid vector from the vectors representing the documents. The classification capability is tested by matching the documents to the centroids, wherein a cosine measurement is used for matching. Before indexing by LSI, the documents are pre-processed by stopword removal. The indexing is performed using augmented normalized term frequency local weighting and inverse document frequency (idf) global weighting. These weighting techniques are described at pages 513-523 of G. Salton and C. Buckley, Term Weighting Approaches in Automatic Text Retrieval, Information Processing and Management, 24(5), 1988. The cited description is incorporated by reference herein.

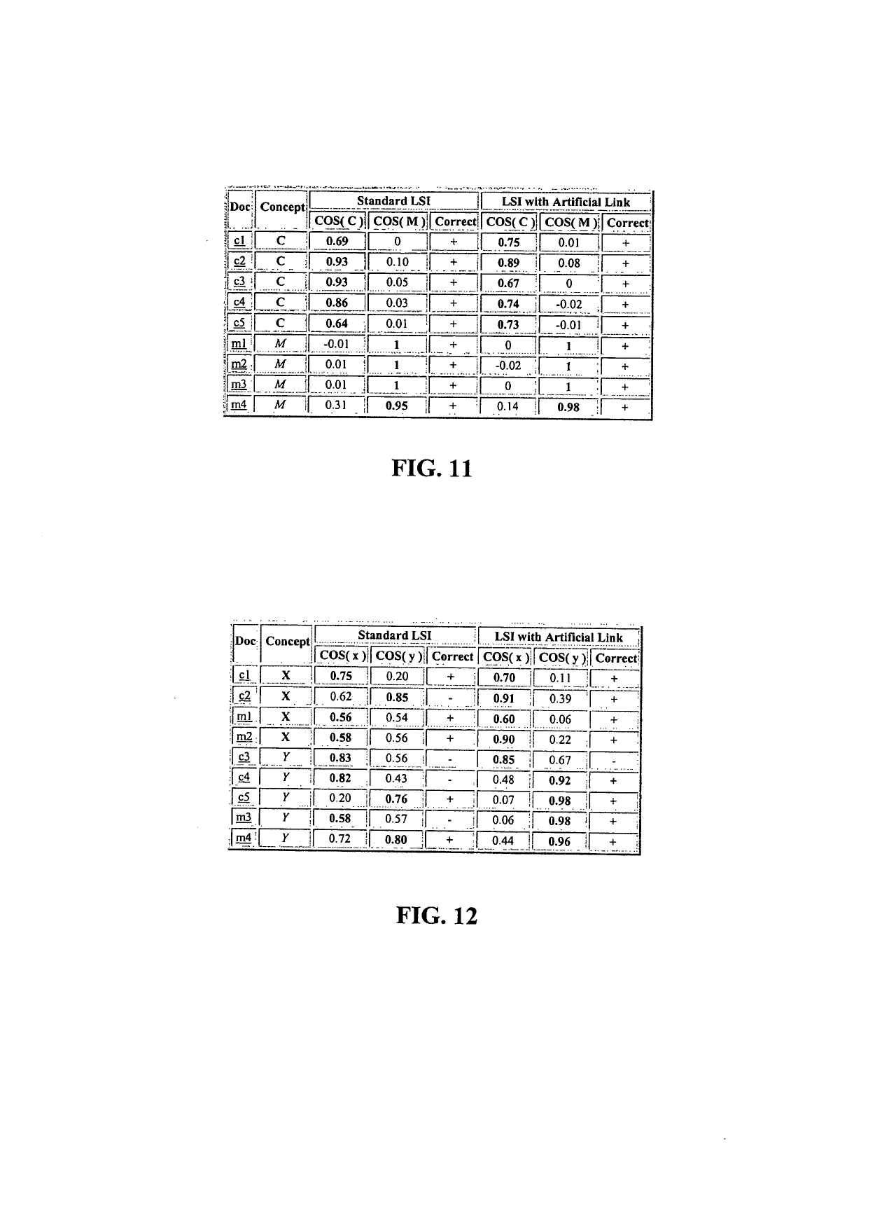

FIG. 11 is a table that illustrates the results from matching documents to concepts C and M created as centroids of documents c1−c5 and m1−m4, respectively. Since c1−c5 and m1−m4 create semantic clusters in the LSI space, the documents c1−c5 used for creating the C centroid are closer to this centroid than to the centroid M. For example, document c1 matches concept C with cosine 0.69, and concept M with cosine 0. In the table of FIG. 11, a correct match is indicated by placing sign ‘+’ next to the cosine measurements. As shown in FIG. 11, a new technique in accordance with the embodiment of the present invention, termed “LSI with Artificial Link”, also creates a representation space in which centroids correctly match their constituent documents. This technique will be described in more detail below.

FIG. 12 is a table that shows results from learning and matching two different concepts. The documents c1−c5 and m1−m4 were arbitrarily regrouped into two concepts, X and Y. Concept X was exemplified by documents: c1, c2, m1, and m2; concept Y was exemplified by documents: c3, c4, c5, m3, and m4. As expected, the centroids created from those groups of documents reflected the mix up, and consequently, the constituent documents matched according to the semantic (LSI) grouping rather than the arbitrary categorization.

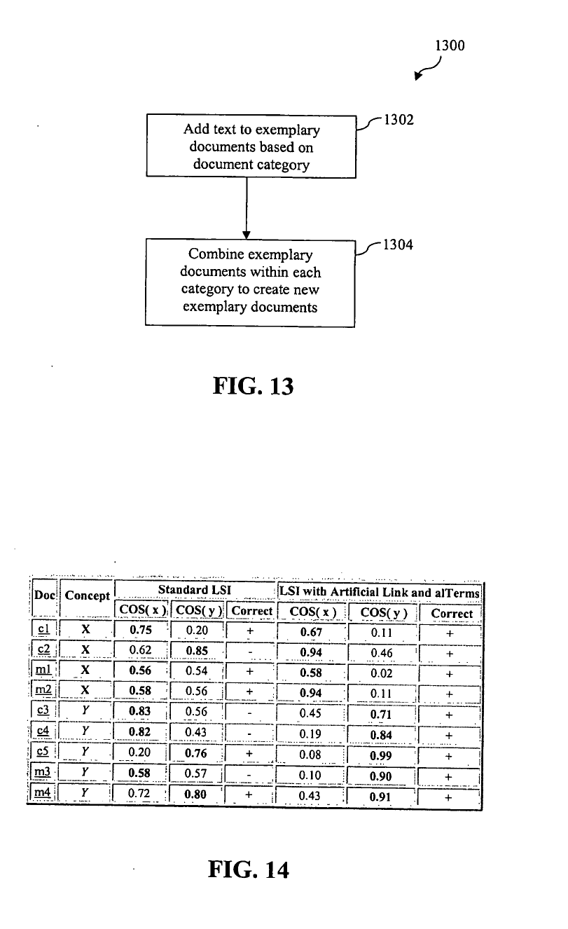

The question arises, how one can influence construction of the LSI space so it could reflect the arbitrary categories. This effect can be achieved by a combination of two operations that adjust the LSI space to reflect the categories. These operations will be described in more detail with reference to the flowchart 1300 of FIG. 13.

As shown in FIG. 13, the first operation 1302 involves adding extra text to the exemplary documents. The text is common for all documents in the category, and may represent for example a label assigned to the category. The added terms, which may be referred to as “artificial link” terms, may be added a different number of times to every document in the set of exemplary documents depending upon the settings of term pruning parameters as well as upon a weight given to the category. For example, documents associated with concept X may be augmented with “category_x” terms. In some cases, the category label contains text that can be simply added to the text of the document. In the case of structured data from a relational table, the table header may be converted into the artificial link term.

The second operation 1304 combines exemplary documents within each category to create new exemplary documents. For example, operation 1304 may concatenate pairs of documents within the same category, thereby creating a “chain link”. For example, given documents associated with concept X (c1, c2, m1, m2), four new documents are created by concatenating c1+c2, c2+m1, m1+m2, and m2+c1. Similarly, five new documents are created from documents associated with concept Y. These nine new documents are then used to create the LSI space. In this space, the centroids are created from the original documents by first folding them into the space, and next creating the centroid. The right parts of the tables of FIGS. 11 and 12 present matching of the original (non-concatenated) documents to the centroids. It can be seen from these tables that the ‘artificial link’ operator made a significant adjustment in the LSI space to accommodate the two concepts.

FIG. 14 is a table that shows results from the combined restructuring achieved by the two operations 1302 and 1304. All the original documents folded into the new LSI space (with no concatenation and added terms) match correctly the centroids created from the folded-in original documents.

As noted above, the foregoing method 1300 can be used as a pre-processing step that creates an altered or “enhanced” set of exemplary documents D for use in creating the LSI representation space in step 104 of flowchart 100 of FIG. 1. Alternatively, step 1302 alone (adding alternative link terms to the exemplary documents) can be used as the pre-processing step, or step 1304 alone (combining exemplary documents from the same category) can be used as the pre-processing step.

E. Use of Alternative Vector Space Representation Methods

Although the foregoing description of an implementation of the present invention is described in terms of application of LSI-based classification and scoring, persons skilled in the relevant art(s) will appreciate that other techniques may be used to generate high-dimensional vector space representations of text objects and their constituent terms. The present invention encompasses the use of such other techniques instead of LSI. For example, such techniques include those described in the following references, each of which is incorporated by reference herein in its entirety: (i) Marchisio, G., and Liang, J., “Experiments in Trilingual Cross-language Information Retrieval, Proceedings”, 2001 Symposium on Document Image Understanding Technology, Columbia, Md., 2001, pp. 169-178; (ii) Hoffman, T., “Probabilistic Latent Semantic Indexing”, Proceedings of the 22^{nd} Annual SIGIR Conference, Berkeley, Calif., 1999, pp. 50-57; (iii) Kohonen, T., Self-Organizing Maps, 3^{rd} Edition, Springer-Verlag, Berlin, 2001; and (iv) Kolda, T., and O.Leary, D., “A Semidiscrete Matrix Decomposition for Latent Semantic Indexing Information Retrieval”, ACM Transactions on Information Systems, Volume 16, Issue 4 (October 1998), pp. 322-346. The representation spaces generated by LSI or any of the other foregoing techniques may be generally referred to as “conceptual representation spaces”.

F. Example Computer System Implementation

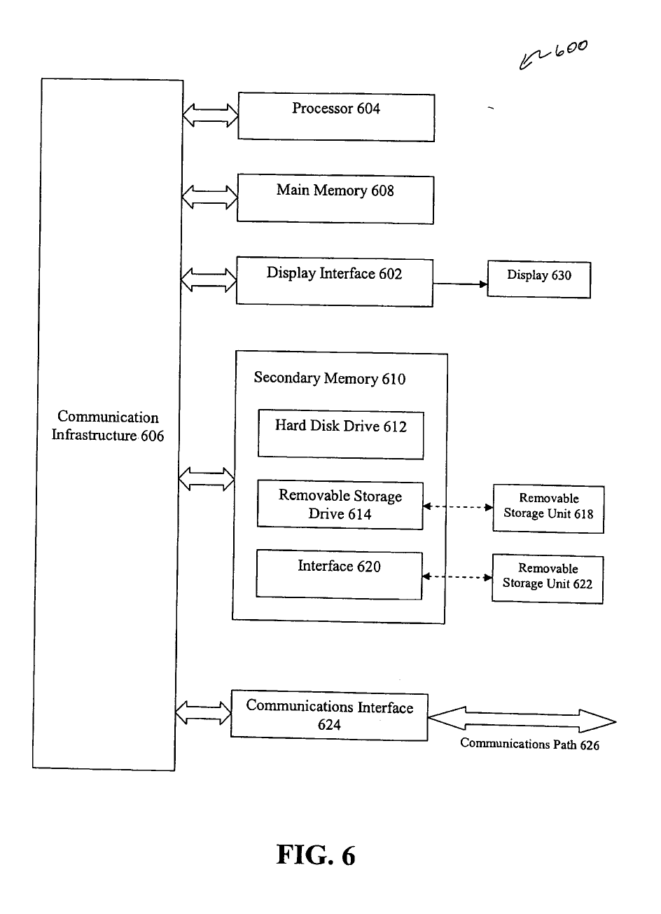

Various aspects of the present invention can be implemented by software, firmware, hardware, or a combination thereof. FIG. 6 illustrates an example computer system 600 in which the present invention, or portions thereof, can be implemented as computer-readable code. For example, the method illustrated by flowchart 100 of FIG. 1 can be implemented in system 600. Various embodiments of the invention are described in terms of this example computer system 600. After reading this description, it will become apparent to a person skilled in the relevant art how to implement the invention using other computer systems and/or computer architectures.

Computer system 600 includes one or more processors, such as processor 604. Processor 604 can be a special purpose or a general purpose processor. Processor 604 is connected to a communication infrastructure 606 (for example, a bus or network).

Computer system 600 also includes a main memory 608, preferably random access memory (RAM), and may also include a secondary memory 610. Secondary memory 610 may include, for example, a hard disk drive 612 and/or a removable storage drive 614. Removable storage drive 614 may comprise a floppy disk drive, a magnetic tape drive, an optical disk drive, a flash memory, or the like. The removable storage drive 614 reads from and/or writes to a removable storage unit 618 in a well known manner. Removable storage unit 618 may comprise a floppy disk, magnetic tape, optical disk, etc. which is read by and written to by removable storage drive 614. As will be appreciated by persons skilled in the relevant art(s), removable storage unit 618 includes a computer usable storage medium having stored therein computer software and/or data.

In alternative implementations, secondary memory 610 may include other similar means for allowing computer programs or other instructions to be loaded into computer system 600. Such means may include, for example, a removable storage unit 622 and an interface 620. Examples of such means may include a program cartridge and cartridge interface (such as that found in video game devices), a removable memory chip (such as an EPROM, or PROM) and associated socket, and other removable storage units 622 and interfaces 620 which allow software and data to be transferred from the removable storage unit 622 to computer system 600.

Computer system 600 may also include a communications interface 624. Communications interface 624 allows software and data to be transferred between computer system 600 and external devices. Communications interface 624 may include a modem, a network interface (such as an Ethernet card), a communications port, a PCMCIA slot and card, or the like. Software and data transferred via communications interface 624 are in the form of signals which may be electronic, electromagnetic, optical, or other signals capable of being received by communications interface 624. These signals are provided to communications interface 624 via a communications path 626. Communications path 626 carries signals and may be implemented using wire or cable, fiber optics, a phone line, a cellular phone link, an RF link or other communications channels.

In this document, the terms “computer program medium” and “computer usable medium” are used to generally refer to media such as removable storage unit 618, removable storage unit 622, a hard disk installed in hard disk drive 612, and signals carried over communications path 626. Computer program medium and computer usable medium can also refer to memories, such as main memory 608 and secondary memory 610, which can be memory semiconductors (e.g. DRAMs, etc.). These computer program products are means for providing software to computer system 600.

Computer programs (also called computer control logic) are stored in main memory 608 and/or secondary memory 610. Computer programs may also be received via communications interface 624. Such computer programs, when executed, enable computer system 600 to implement the present invention as discussed herein. In particular, the computer programs, when executed, enable processor 604 to implement the processes of the present invention, such as the steps in the method illustrated by flowchart 100 of FIG. 1 discussed above. Accordingly, such computer programs represent controllers of the computer system 600. Where the invention is implemented using software, the software may be stored in a computer program product and loaded into computer system 600 using removable storage drive 614, interface 620, hard drive 612 or communications interface 624.

The invention is also directed to computer products comprising software stored on any computer useable medium. Such software, when executed in one or more data processing device, causes a data processing device(s) to operate as described herein. Embodiments of the invention employ any computer useable or readable medium, known now or in the future. Examples of computer useable mediums include, but are not limited to, primary storage devices (e.g., any type of random access memory), secondary storage devices (e.g., hard drives, floppy disks, CD ROMS, ZIP disks, tapes, magnetic storage devices, optical storage devices, MEMS, nanotechnological storage device, etc.), and communication mediums (e.g., wired and wireless communications networks, local area networks, wide area networks, intranets, etc.).

G. Conclusion

While various embodiments of the present invention have been described above, it should be understood that they have been presented by way of example only, and not limitation. It will be understood by those skilled in the relevant art(s) that various changes in form and details may be made therein without departing from the spirit and scope of the invention as defined in the appended claims. Accordingly, the breadth and scope of the present invention should not be limited by any of the above-described exemplary embodiments, but should be defined only in accordance with the following claims and their equivalents.

What is claimed is:

1. A method for generating a function for the automatic classification of documents, comprising:
calculating a set of similarity scores for each document in a set of exemplary documents, wherein a similarity score is calculated by measuring the similarity in a conceptual representation space between a document vector representing the document and a centroid vector representing a category;
generating the function for the automatic classification of documents in an inductive learning from examples classifier based at least on the set of similarity scores for each document.

2. The method of claim 1, wherein the conceptual representation space is a Latent Semantic Indexing (LSI) representation space.

3. The method of claim 1, further comprising:
generating the conceptual representation space based on the set of exemplary documents.

4. The method of claim 1, further comprising:
assigning each document in the set of exemplary documents to a category, thereby generating categorized subsets of the set of exemplary documents;
generating one or more centroid vectors for each of the categorized subsets of documents in the conceptual representation space.

5. The method of claim 4, wherein generating the function for the automatic classification of documents in an inductive learning from examples classifier based at least on the set of similarity scores for each document comprises:
generating the function for the automatic classification of documents in an inductive learning from examples classifier based on at least the set of similarity scores for each document and the category assigned to each document.

6. The method of claim 1, wherein generating the function for the automatic classification of documents in an inductive learning from examples classifier comprises generating a decision rule.

7. A method for automatically classifying a document, comprising:
representing the document in a conceptual representation space;
calculating a set of similarity scores for the document, wherein a similarity score is calculated by measuring the similarity in the conceptual representation space between a document vector representing the document and a centroid vector representing a category;
classifying the document in an inductive learning from examples classifier based at least on the set of similarity scores for the document.

8. The method of claim 7, wherein the conceptual representation space is a Latent Semantic Indexing (LSI) representation space.

9. The method of claim 7, wherein representing the document in the conceptual representation space comprises folding the document into the conceptual representation space.

10. The method of claim 7, wherein representing the document in the conceptual representation space comprises generating the conceptual representation space using the document.

11. The method of claim 7, wherein measuring the similarity in the conceptual representation space between the document vector and the centroid vector comprises calculating a cosine or dot product using the document vector and the centroid vector.

12. The method of claim 7, wherein classifying the document in an inductive learning from examples classifier comprises applying a decision rule.

13. A method for generating a function for the automatic classification of data records, wherein each data record includes a field of unstructured information and a field of structured information, the method comprising:
for each data record, calculating a set of similarity scores for the corresponding field of unstructured information, wherein a similarity score is calculated by measuring the similarity in a conceptual representation space between a vector representing the unstructured information and a centroid vector representing a category; and
generating the function for the automatic classification of data records in an inductive learning from examples classifier based on at least the set of similarity scores and the field of structured information associated with each data record.

14. The method of claim 13, wherein the conceptual representation space is a Latent Semantic Indexing (LSI) representation space.

15. The method of claim 13, further comprising:
generating the conceptual representation space based on the fields of unstructured information associated with the data records.

16. The method of claim 13, further comprising:
assigning each data record to one of a plurality of categories;
generating one or more centroid vectors for each category in the plurality of categories based on the field(s) of unstructured information associated with the data record(s) assigned to the category.

17. The method of claim 13, wherein generating the function for the automatic classification of data records in an inductive learning from examples classifier based at least on the set of similarity scores and the field of structured information associated with each data record comprises:
generating the function for the automatic classification of data records in an inductive learning from examples classifier based on at least the set of similarity scores, the field of structured information and the category associated with each data record.

18. The method of claim 13, wherein generating the function for the automatic classification of data records in an inductive learning from examples classifier comprises generating a decision rule.

19. A method for automatically classifying a data record that includes a field of unstructured information and a field of structured information, the method comprising:
representing the unstructured information in a conceptual representation space;
calculating a set of similarity scores for the field of unstructured information, wherein a similarity score is calculated by measuring the similarity in a conceptual representation space between a vector representing the unstructured information and a centroid vector representing a category; and
classifying the data record in an inductive learning from examples classifier based at least on the set of similarity scores and the field of structured information.

20. The method of claim 19, wherein the conceptual representation space is a Latent Semantic Indexing (LSI) representation space.

21. The method of claim 19, wherein representing the unstructured information in the conceptual representation space comprises folding the unstructured information into the conceptual representation space.

22. The method of claim 19, wherein representing the unstructured information in the conceptual representation space comprises generating the conceptual representation space using the unstructured information.

23. The method of claim 19, wherein measuring the similarity in the conceptual representation space between the vector representing the unstructured information and the centroid vector comprises calculating a cosine or dot product using the vector representing the unstructured information and the centroid vector.

24. The method of claim 19, wherein classifying the data record in an inductive learning from examples classifier comprises applying a decision rule.

25. A method for creating a representation space for use in classifying documents, comprising:
receiving a set of exemplary documents;
assigning each document in the set of exemplary documents to one of a plurality of categories;
adding text to each of the exemplary documents, wherein the text added to each of the exemplary documents is representative of a concept associated with the category to which the document has been assigned, thereby creating a set of augmented exemplary documents; and
generating the representation space based on the augmented exemplary documents.

26. The method of claim 25, wherein generating the representation space based on the augmented exemplary documents comprises performing latent semantic indexing.

27. The method of claim 25, wherein adding text to each of the exemplary documents comprises adding a category label to each of the exemplary documents.

28. The method of claim 25, wherein generating the representation space based on the augmented exemplary documents comprises:
combining documents within the set of augmented exemplary documents that are assigned to the same category, thereby creating a set of combined documents; and
generating the representation space based on the combined documents.

29. The method of claim 28, wherein combining documents within the set of augmented exemplary documents that are assigned to the same category comprises:
concatenating pairs of documents in a series of augmented exemplary documents assigned to the same category such that each document in the series is concatenated to each adjacent document in the series.
